(19) United States
(12) Patent Application Publication
(10) Pub. No.: US 2024/0115996 A1
(43) Pub. Date: Apr. 11, 2024

(54) METHODS AND SYSTEMS FOR REDUCING NITROGEN OXIDES (NOx) IN A HEAT GENERATION UNIT USING SOUR WATER STRIPPER VAPOR

(71) Applicant: MARATHON PETROLEUM COMPANY LP, Findlay, OH (US)

(72) Inventors: David C. Rudd, Findlay, OH (US); Alexander F. Lueker, Findlay, OH (US)

(21) Appl. No.: 18/376,117

(22) Filed: Oct. 3, 2023

Related U.S. Application Data
(60) Provisional application No. 63/378,821, filed on Oct. 7, 2022.

(51) Int. Cl. B01D 53/56; B01D 53/76

(52) U.S. Cl. CPC B01D 53/56; B01D 53/76; B01D 2251/2062; B01D 2257/404; B01D 2258/02

(57) ABSTRACT

Methods and systems for reducing NOₓ in a heat generation unit are provided. A method includes introducing an exhaust gas from a catalytic cracking unit to a combustion zone of a heat generation unit to produce a combusted exhaust gas, wherein the exhaust gas contains two or more of carbon monoxide, hydrogen cyanide, ammonia, and nitrogen oxide. The method further includes introducing a sour water stripper (SWS) vapor stream from a SWS unit to the heat generation unit at a location after the combustion zone and before a heat recovery zone of the heat generation unit. The method also includes allowing the SWS vapor stream to react with the combusted exhaust gas to produce a processed exhaust gas with decreased NOₓ content as compared to the NOₓ content when the exhaust gas is processed under similar conditions but without an interaction with the SWS vapor stream.

### CROSS-REFERENCE TO RELATED APPLICATIONS

The present application claims priority to and the benefit of U.S. Provisional Application No. 63/378,821, filed Oct. 7, 2022, titled “Methods and Systems for Reducing Nitrogen Oxide Emissions in a Heat Generation Unit using Sour Water Stripper Vapor,” the disclosure of which is incorporated herein by reference in its entirety for all purposes.

### TECHNICAL FIELD

The present disclosure generally relates to methods and systems for reducing nitrogen oxides (NOₓ) in a heat generation unit using a sour water stripper vapor stream as a selective non-catalytic reduction reagent. More specifically, the present disclosure relates to methods for decreasing NOₓ emissions generated during the combustion of exhaust gas produced within the operation of a fluid catalytic cracking unit by using sour water stripper off-gas as a selective non-catalytic reduction reagent.

### BACKGROUND

In the hydrocarbon processing industry, the operation of a fluid catalytic cracking unit (FCCU) exhausts regeneration (regen) gas containing two or more of carbon monoxide (CO), hydrogen cyanide (HCN), ammonia (NH₃), and NOₓ gases. To reclaim the energy from the exhaust gas and decrease CO emission, a heat generation unit may be included in the FCCU design or operably connected to the FCCU to combust CO in the regen gas and generate steam. Depending on the operating mode of the FCCU, the regen gas may contain varying concentrations of nitrogen species, such as HCN, NH₃, and NOₓ. In addition to the NOₓ that may be present in the regen gas, the other nitrogen-containing compounds in the regen gas are sources of thermally-produced NOₓ in the heat generation unit. In addition to other methods of decreasing NOₓ emissions, NOₓ may be reduced using a selective non-catalytic reduction (SNCR) system. However, the use of a SNCR system typically involves the purchase of urea or NH₃ and the ability to transport and store the material on site. Further, if NH₃ is utilized, additional precautions are required due to its toxicity. Additionally, this stored material is pumped, vaporized/atomized (often with air or steam), and injected into the unit, posing increased operational costs and safety hazards.

### SUMMARY

There is a need for methods and systems capable of safely and economically reducing nitrogen oxide emissions from a heat generation unit. To address these shortcomings in the art, Applicant has developed methods and systems for decreasing NOₓ emissions by reducing NOₓ that is present within an exhaust gas, as well as NOₓ generated during combustion of the exhaust gas, by using sour water stripper (SWS) off-gas as a selective non-catalytic reduction reagent, to decrease NOₓ emissions, in accordance with the example embodiments disclosed herein.

Embodiments of methods for reducing NOₓ in a heat generation unit are provided. In certain embodiments, a method for reducing NOₓ in a heat generation unit includes the steps of introducing an exhaust gas from a catalytic cracking unit to a combustion zone of a heat generation unit to produce a combusted exhaust gas, introducing a SWS vapor stream from a SWS unit to the heat generation unit at a location after the combustion zone and before a heat recovery zone of the heat generation unit, and allowing the SWS vapor stream to react with the combusted exhaust gas to produce a processed exhaust gas with a decreased NOₓ content compared to a NOₓ content when the exhaust gas is processed under similar conditions but without an interaction with the SWS vapor stream. The exhaust gas contains two or more of CO, HCN, NH₃, and NOₓ.

Embodiments of methods for operating a heat generation unit are provided. In certain embodiments, the method for operating a heat generation unit includes the steps of combusting a regen gas stream in a combustion zone of the heat generation unit to produce a combusted regen gas that contains NOₓ, injecting a SWS vapor stream that contains NH₃ as a SNCR reagent into a post-combustion zone of the heat generation unit, and allowing the NH₃ of the SWS vapor stream to react with the NOₓ of the combusted regen gas in the post-combustion zone of the heat generation unit to produce a processed exhaust gas having a decreased NOₓ content. In certain embodiments, the steps include receiving the regen gas stream from a fluid catalytic cracking unit, wherein the regen gas stream contains CO and one or more nitrogen-containing compounds. In certain embodiments, the one or more nitrogen-containing compounds are selected from the group consisting of: HCN, NH₃, and NOₓ. In certain embodiments, the steps include receiving the SWS vapor stream from a SWS unit, wherein the SWS vapor further contains steam and H₂S. The post-combustion zone can be located downstream of the combustion zone and upstream of a heat recovery zone of the heat generation unit.

In certain embodiments, the SWS vapor stream is introduced in at least two or three temperature sections of the heat generation unit. The temperature sections can be defined by an average temperature of the combusted exhaust gas. The temperature sections can be defined by a range of temperature of the combusted exhaust gas. In certain embodiments, the temperature of the combusted exhaust gas in a first temperature section ranges from about 1600° F. to about 1800° F. and the temperature of the combusted exhaust gas in a second temperature section ranges from above 1800° F. to about 2200° F. In certain embodiments, the temperature of the combusted exhaust gas in a first temperature section ranges from about 1600° F. to about 1800° F., the temperature of the combusted exhaust gas in a second temperature section ranges from above 1800° F. to about 1900° F., and the temperature of the combusted exhaust gas in a third temperature section ranges from above 1900° F. to about 1955° F. In some embodiments, the processed exhaust gas contains less than 300 parts per million by volume-dry (ppmvd) of NOₓ, less than 1 part per million by volume-wet (ppmvw) of CO, and about 20 ppmvd or less of NH₃. In some embodiments, the processed exhaust gas contains about 100 ppmvd or less of NOₓ and about 5 ppmvd or less of NH₃. In some embodiments, the decreased NOₓ content of the processed exhaust gas is at least 30% less than a NOₓ content of the combusted regen gas.

Embodiments of systems for reducing NOₓ in a heat generation unit are provided. An embodiment of a heat generation system includes an exhaust gas conduit for conveying exhaust gas from a cracking unit to a furnace unit; the furnace unit containing (i) a combustion zone to receive and facilitate combustion of the exhaust gas to produce combusted exhaust gas, (ii) a post-combustion zone equipped with a plurality of inlets to inject a plurality of SWS vapor streams from a SWS unit into the combusted exhaust gas from the combustion zone to produce the processed exhaust gas, and (iii) a heat recovery zone to capture heat from the processed exhaust gas; and a vent conduit for emission of the processed exhaust gas after passing through the heat recovery zone. In certain embodiments, the plurality of inlets includes at least one inlet disposed in each of at least two or three temperature sections in the post-combustion zone. The temperature sections can be defined by an average temperature of the combusted exhaust gas. The temperature sections can be defined by a range of temperature of the combusted exhaust gas. In certain embodiments, the temperature of the combusted exhaust gas in a first temperature section ranges from about 1600° F. to about 1800° F. and the temperature of the combusted exhaust gas in a second temperature section ranges from above 1800° F. to about 2200° F. In certain embodiments, the temperature of the combusted exhaust gas in a first temperature section ranges from about 1600° F. to about 1800° F., the temperature of the combusted exhaust gas in a second temperature section ranges from above 1800° F. to about 1900° F., and the temperature of the combusted exhaust gas in a third temperature section ranges from above 1900° F. to about 1955° F.

In an embodiment, a system includes a SWS unit configured to generate a SWS vapor stream that contains NH₃ and steam. The system includes a CO boiler containing a combustion zone and a post-combustion zone, the post-combustion zone having SNCR nozzles configured to receive and inject a portion of the SWS vapor stream into a combusted exhaust gas from the combustion zone to produce a processed exhaust gas having decreased NOₓ content. In some embodiments, the system includes a fluid catalytic cracking unit in fluid communication with the CO boiler and configured to provide a regen gas stream to the combustion zone of the CO boiler, and at least the regen gas stream is combusted in the combustion zone to generate the combusted exhaust gas. In some embodiments, a second portion of the SWS vapor stream is combined with the regen gas stream before being combusted together in the combustion zone to generate the combusted exhaust gas. The processed exhaust gas can contain less than 300 ppmvd of NOₓ, less than 1 ppmvw of CO, and about 20 ppmvd or less of NH₃. In some embodiments, the CO boiler is a wall-fired CO boiler or a tangentially-fired CO boiler. In certain embodiments, a molar ratio of NH₃ to NOₓ in the post-combustion zone is between about 1.8 and about 3.1.

In some embodiments of the methods and systems, the cracking unit is a fluid catalytic cracking unit. In some embodiments of the methods and systems, the NOₓ content in the processed exhaust gas is about thirty percent less than the NOₓ content when the exhaust gas is processed under similar conditions but without an interaction with the SWS vapor stream. In some embodiments of the methods and systems, the NOₓ content in the processed exhaust gas is about fifty percent less than the NOₓ content when the exhaust gas is processed under similar conditions but without an interaction with the SWS vapor stream. In some embodiments of the methods and systems, the NOₓ content in the processed exhaust gas is about seventy percent less than the NOₓ content when the exhaust gas is processed under similar conditions but without an interaction with the SWS vapor stream.

Still other aspects and advantages of these example embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to illustrate embodiments of the disclosure more clearly.

FIG. 1 is a diagrammatic representation of a system for reducing NOₓ in a heat generation unit using SWS vapor as a SNCR reagent, according to an embodiment of the disclosure.

FIG. 2 is an illustration from Computational Fluid Dynamics (CFD) modeling of the exhaust gas temperatures for baseline operation of a wall-fired CO boiler as an example heat generation unit, according to an embodiment of the disclosure.

FIG. 3 is a graphical representation of the average gas temperatures versus boiler length for a baseline case and for two modification cases involving relocation of a portion of the SWS vapor stream to SNCR ports located in the post-combustion zone, according to an embodiment of the disclosure.

FIG. 4 is a graphical representation of the average CO concentrations versus boiler length for the baseline case and for the two modification cases involving relocation of a portion of the SWS vapor stream to SNCR ports located in the post-combustion zone, according to an embodiment of the disclosure.

FIGS. 5 and 6 are graphical representations of NOₓ concentrations and NH₃ concentrations, respectively, for the baseline case in comparison with the two modification cases involving relocation of a portion of the SWS vapor stream to SNCR ports located in the post-combustion zone, according to an embodiment of the disclosure.

FIG. 7 is a graphical representation of NOₓ concentration as a function of boiler height for the baseline case and for three modification cases involving increased SWS vapor stream flow rates through the SNCR ports located in the post-combustion zone, according to an embodiment of the disclosure.

FIG. 8 is a graphical representation of NH₃ concentration as a function of boiler height for the baseline case and for the three modification cases involving increased SWS vapor stream flow rates through the SNCR ports located in the post-combustion zone, according to an embodiment of the disclosure.

FIG. 9 is a graphical representation of an isothermal plug flow calculation of H₂S oxidation, according to an embodiment of the disclosure.

FIGS. 10A and 10B are illustrations from the CFD modeling of the NOₓ profiles of SNCR case (FIG. 10B) in comparison with the baseline case (FIG. 10A), according to an embodiment of the disclosure.

### DETAILED DESCRIPTION

The present disclosure describes various embodiments related to processes, methods, and systems for integrating petrochemical and refinery operations. Further embodiments may be described and disclosed.

In the following description, numerous details are set forth in order to provide a thorough understanding of the various embodiments. In other instances, well-known processes, devices, and systems may not have been described in particular detail in order not to unnecessarily obscure the various embodiments. Additionally, illustrations of the various embodiments may omit certain features or details in order to not obscure the various embodiments.

The description may use the phrases “in some embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The use of the words “a” or “an” when used in conjunction with any of the terms “comprising,” “including,” “containing,” or “having” in the claims or the specification may mean “one,” but are also consistent with the meaning of “one or more,” “at least one,” and “one or more than one.” The terms “wt. %”, “vol. %”, or “mol. %” refer to a weight, volume, or molar percentage of a component, respectively, based on the total weight, the total volume of material, or total moles, that includes the component. In a non-limiting example, 10 grams of a component in 100 grams of the material is 10 wt. % of the component.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “NOₓ” refers to nitrogen oxide (NO), or nitrogen dioxide (NO₂), or combinations thereof.

Heat generation units as described here include all types of furnaces and boilers that process exhaust gases by combustion under adequate temperature and residence time to generate heat. Disclosed here is a method for reducing NOₓ in a heat generation unit that processes exhaust gases containing two or more of CO, HCN, NH₃, and NOₓ generated from a catalytic cracking unit. There are several sources of NOₓ in a refinery, including regen gas that is an exhaust gas of a cracking unit. The Applicant has determined that the use of a waste stream from a sour water stripper (SWS) as a SNCR reagent can result in significant decreases in NOₓ emission. Implementation of systems and methods disclosed herein also reduce or avoid significant equipment, operating, and maintenance costs for installation of a SNCR system. In certain embodiments, the heat generation unit can be any thermal oxidizer with a heat recovery system. In certain embodiments, the heat generation unit is a carbon monoxide (CO) boiler used to oxidize CO-rich waste gases typically generated by a catalytic cracking unit. Additionally, the use of a waste stream from a SWS as a SNCR reagent provides an alternative disposition for the waste stream that further minimizes emissions and costs associated with processing waste stream in a fluid catalytic cracking unit operation. The presently disclosed methods are operable to reduce NOₓ in a heat generation unit by introducing SWS vapor to the heat generation unit at a location after the combustion zone, where the SWS vapor can act as a SNCR reagent. Sour water stripping is used to remove NH₃ and H₂S from SWS vapor streams generated from distillation, fluid catalytic cracking, catalytic reforming, coker and acid gas removal units, etc. in a refinery. SWS vapor can be mixed with the regen gas, then combusted in a heat generation unit. The presence of NH₃ in the SWS vapor has potential to generate a significant quantity of fuel NOₓ emissions in the heat generation unit. The amount of NOₓ emission was decreased by relocating a portion of the SWS vapor stream from the combustion zone to the post-combustion zone in the heat generation unit under adequate temperature and residence time conditions, where the SWS vapor acts as a SNCR reagent. In addition to the NOₓ reduction, there can be a decrease in the H₂S emissions by relocation of the SWS vapor stream.

Embodiments of systems for reducing NOₓ in a heat generation unit are provided. An embodiment of a heat generation system includes an exhaust gas conduit for conveying exhaust gas from a cracking unit to a furnace unit; the furnace unit containing (i) a combustion zone to receive and facilitate combustion of the exhaust gas to produce combusted exhaust gas, (ii) a post-combustion zone equipped with a plurality of inlets to inject a plurality of SWS vapor streams from a SWS unit into the combusted exhaust gas from the combustion zone to produce the processed exhaust gas, and (iii) a heat recovery zone to capture heat from the processed exhaust gas; and a vent conduit for emission of the processed exhaust gas after passing through the heat recovery zone. In certain embodiments, the plurality of inlets includes at least one inlet disposed in each of at least two or three temperature sections in the post-combustion zone. The temperature sections can be defined by an average temperature of the combusted exhaust gas. The temperature sections can be defined by a range of temperature of the combusted exhaust gas. In certain embodiments, the temperature of the combusted exhaust gas in a first temperature section ranges from about 1600° F. (871° C.) to about 1800° F. (982° C.) and the temperature of the combusted exhaust gas in a second temperature section ranges from above 1800° F. to about 2200° F. (1204° C.). In certain embodiments, the temperature of the combusted exhaust gas in a first temperature section ranges from about 1600° F. to about 1800° F., the temperature of the combusted exhaust gas in a second temperature section ranges from above 1800° F. to about 1900° F. (1038° C.), and the temperature of the combusted exhaust gas in a third temperature section ranges from above 1900° F. to about 1955° F. (1068° C.).

Embodiments disclosed here include SNCR processes using SWS vapor as a SNCR reagent for NOₓ control in two heat generation configurations. In both configurations, some or all of the SWS vapor is mixed with the exhaust gas after the combustion zone, subsequently generating a significantly decreased amount of NOₓ and H₂S emissions.

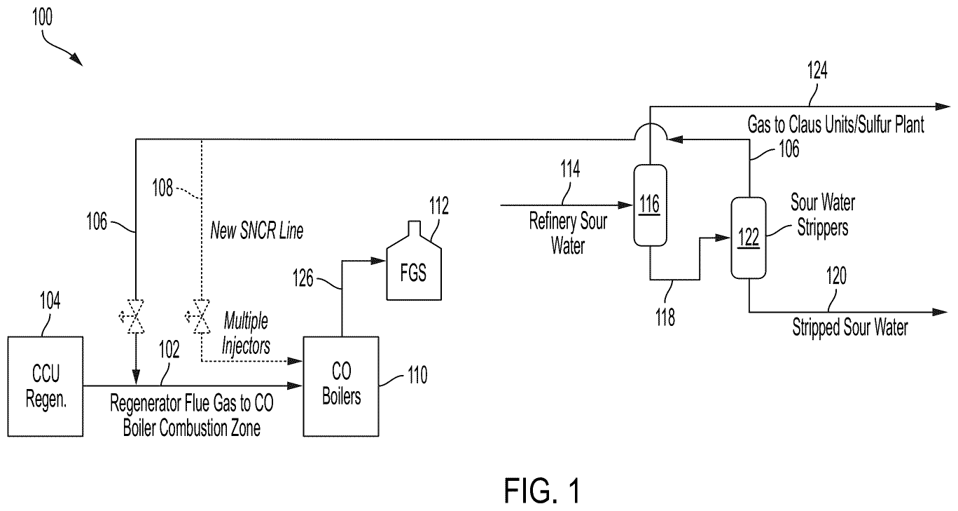

FIG. 1 is a diagrammatic representation of a system 100 for reducing NOₓ in a heat generation unit 110, such as a furnace or a boiler, resulting in decreased NOₓ emissions. An exhaust gas stream containing NOₓ 102 is generated at a cracking regeneration unit 104 situated within the operation of a cracking process. In certain embodiments, the cracking process is a fluid catalytic cracking process. For example, in certain embodiments, the exhaust gas feed stream 102 contains two or more of CO, HCN, NH₃, and NOₓ. The exhaust gas feed stream 102 is supplied to the heat generation unit 110, which is operable to reclaim the energy in the exhaust gas feed stream 102 and decrease CO emission. The heat generation unit 110 is operated to process the exhaust gas feed stream 102 alone or to process a mixture of the exhaust gas feed stream 102 with a SWS vapor stream 106 (also referred to herein as a sour water off-gas stream) at a combustion zone to produce a combusted exhaust gas. Embodiments of the system 100 include diverting at least a portion of the SWS vapor stream 106 (indicated as relocated SWS vapor stream 108 in FIG. 1) to injection points downstream of the combustion zone in the heat generation unit 110. NOₓ is present in the heat generation unit 110 either as part of the exhaust gas feed stream 102 or as a product when the exhaust gas feed stream 102 is processed in the combustion zone of the heat generation unit 110.

The heat generation unit 110 is operable to deliver the relocated SWS vapor stream 108 at a location after the combustion zone and before a heat recovery zone, in order to react the combusted exhaust gas with the relocated SWS vapor stream 108 and produce a processed exhaust gas 126 with decreased NOₓ content compared to NOₓ content when the exhaust gas is processed under similar conditions, but without the relocated SWS vapor stream 108. In certain embodiments, the processed exhaust gas contains about 10 percent (%) less NOₓ content compared to the NOₓ content when the exhaust gas is processed under similar conditions, but without the relocated SWS vapor stream. In certain embodiments, the processed exhaust gas contains about 20% less NOₓ content compared to the NOₓ content when the exhaust gas is processed under similar conditions, but without the relocated SWS vapor stream. In certain embodiments, the processed exhaust gas contains about 30% less NOₓ content compared to the NOₓ content when the exhaust gas is processed under similar conditions, but without the relocated SWS vapor stream. In certain embodiments, the processed exhaust gas contains about 40% less NOₓ content compared to the NOₓ content when the exhaust gas is processed under similar conditions, but without the relocated SWS vapor stream. In certain embodiments, the processed exhaust gas contains about 50% or less NOₓ content compared to the NOₓ content when the exhaust gas is processed under similar conditions, but without the relocated SWS vapor stream. In certain embodiments, the processed exhaust gas contains about 70% or less NOₓ content compared to NOₓ content when the exhaust gas is processed under similar conditions, but without the relocated SWS vapor stream. The example system 100 may also include an additional emissions control unit 112 operable to remove other pollutants present in the processed exhaust gas 126.

In certain embodiments, the processed exhaust gas 126 contains less than 1 part per million by volume-wet (ppmvw) of CO. In certain embodiments, the processed exhaust gas contains less than 350 parts per million by volume, dry (ppmvd) of NOₓ. The processed exhaust gas may contain less than 340 ppmvd of NOₓ, less than 330 ppmvd of NOₓ, or less than 320 ppmvd of NOₓ. In some embodiments, the processed exhaust gas contains less than 310 ppmvd of NOₓ or about 305 ppmvd of NOₓ. In some embodiments, the processed exhaust gas contains less than 310 ppmvd of NOₓ or about 305 ppmvd of NOₓ. In some embodiments, the processed exhaust gas contains less than 300 ppmvd of NOₓ, less than 275 ppmvd of NOₓ, less than 250 ppmvd of NOₓ, or less than 200 ppmvd of NOₓ. In some embodiments, the processed exhaust gas contains less than 190 ppmvd of NOₓ, less than 175 ppmvd of NOₓ, less than 150 ppmvd of NOₓ, or less than 125 ppmvd of NOₓ. In some embodiments, the processed exhaust gas contains less than 100 ppmvd of NOₓ or less than 75 ppmvd of NOₓ.

The example embodiment of the system 100 also includes a refinery sour water 114 fed to a first SWS 116, which may come from, but not limited to, a connection with a distillation unit, a fluid catalytic cracking unit, or a catalytic reforming unit in a refinery to produce a SWS stream 118 and a waste gas stream 124. The SWS stream 118 is a partially stripped and rectified sour water stream. The first SWS 116 functions to remove H₂S in waste gas stream 124 while segregating NH₃ in the liquid phase SWS stream 118. The waste gas stream 124 from the first SWS 116 is supplied to a Claus unit or other sulfur processing units. The liquid phase from the first SWS 116 is supplied to a second SWS 122 to produce a stripped sour water 120 and the SWS vapor stream 106. In certain embodiments, the SWS vapor streams 106 and 108 primarily contain saturated steam and NH₃. The SWS vapor streams can be produced from an unquenched second stage SWS overhead with trace hydrocarbon and sulfur species and can be directed for SNCR reactions in furnaces and boilers. The SWS vapor can be injected at multiple locations inside the heat generation unit to provide a good distribution of NH₃.

### EXAMPLES

The examples provided below illustrate selected aspects of the various embodiments of systems and methods of utilizing SWS vapor as a SNCR reagent in a heat generation unit.

### Example 1

Two configurations of the heat generation unit were analyzed. CFD-based evaluation performed on two typical styles of CO boilers (COB) demonstrated that significant NOₓ reduction was obtained by relocating SWS vapor from the combustion zone to downstream SNCR ports in the boilers. NOₓ reduction is dependent on the regen gas temperature, available residence time, and the mixing of SNCR reagent and regen gas. NOₓ reduction is also impacted by the amount of SWS vapor that was directed to the SCNR ports, with higher NOₓ reduction seen with higher SWS rates to the SNCR ports. There was also significant H₂S oxidation at SNCR zone temperatures.

The first configuration includes a wall-fired boiler as an illustrative example of a heat generation unit. The wall-fired CO boiler includes fuel gas burners that are fired horizontally from the end of the boiler, while regen gas mixed with SWS vapor is injected into the combustion zone from the top of the boiler. The CFD evaluation included the relocation of a portion of the SWS vapor stream to SNCR ports located in the post-combustion zone, instead of this portion of the SWS vapor stream being combined with the regen gas and combusted in the combustion zone of the CO boiler. Different SWS vapor stream flow rates to the combustion and SNCR zones were evaluated through the CFD simulations in order to determine optimum operation for NOₓ reduction.

The second configuration includes a tangentially-fired CO boiler as an illustrative example of a heat generation unit. In this style of CO boiler, the regen gas ports and the fuel gas burners are located at the corners of the CO boiler, with the burner region of the boiler lined with a refractory material and the upper region of the boiler enclosed with bare waterwall tubes. In this configuration, a portion of the SWS vapor stream was relocated to SNCR ports installed above the burner region, where conditions were more favorable for SNCR chemistry, instead of this portion of the SWS vapor stream being combined with the regen gas and combusted in the combustion zone of the CO boiler. Different SWS vapor stream flow rates to the regen gas and SNCR ports were evaluated in order to optimize operation for NOₓ reduction.

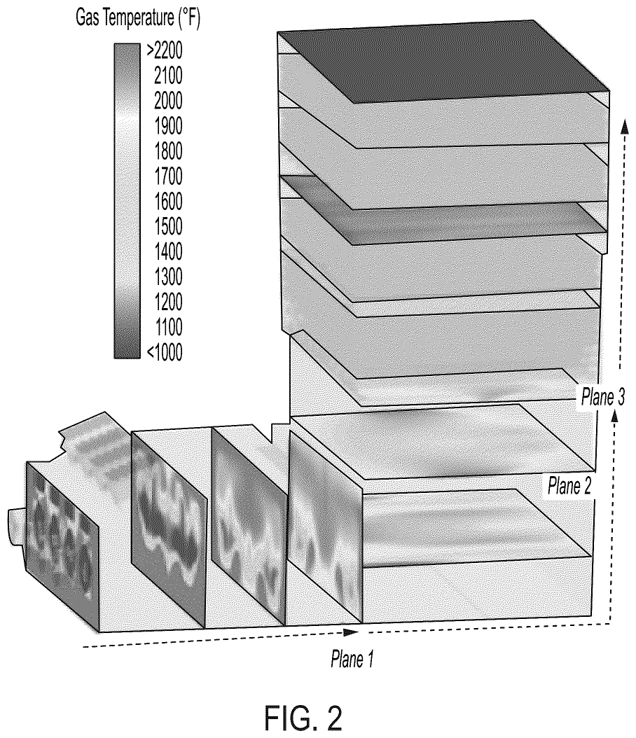

The CFD model was a three-dimensional, reacting CFD model from Reaction Engineering International that has been extensively utilized to simulate gas-fired combustion applications that demand an accurate treatment of chemistry and turbulence-chemistry interactions. FIG. 2 is an illustration from the CFD modeling of the regen gas temperatures for baseline operation of a wall-fired CO boiler. The gas temperature profile under baseline operation reveals different temperature sections. Even though some temperature variations are observed, the overall gas temperatures between plane 1 and plane 3 are favorable for SNCR, with residence time between plane 2 and plane 3 adequate for SNCR chemistry. Although the CO concentration is relatively high in the horizontal combustion region, the CFD-predicted average CO concentration is very low after the gases make the 90° turn (i.e., plane 2). Most of the NOₓ that is formed within the CO boiler is formed in the horizontal combustion section, with some formed between plane 1 and plane 2. The NOₓ formation chemistry is essentially quenched after plane 2.

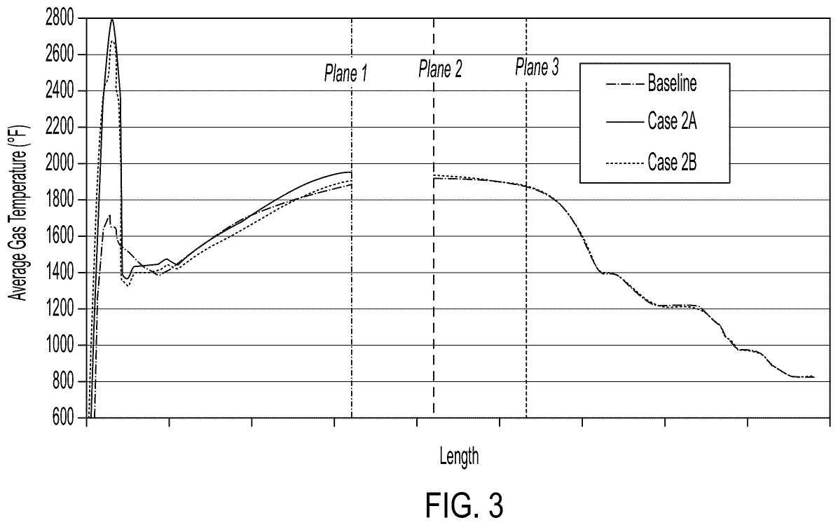

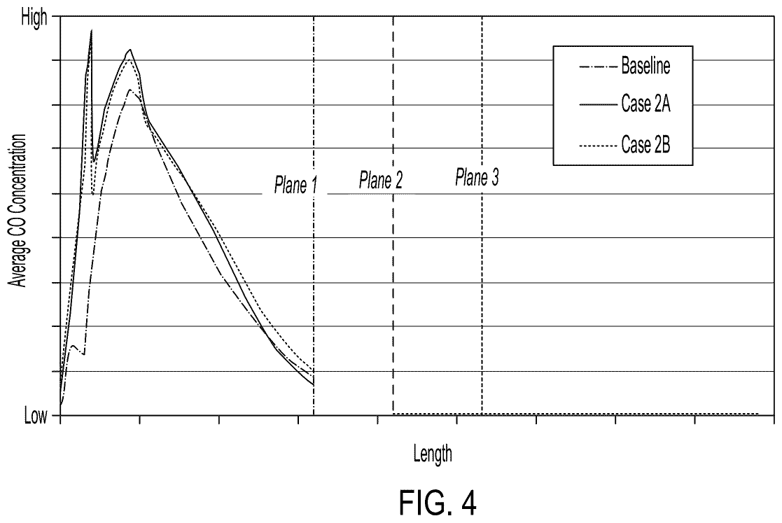

FIGS. 3 and 4 show average flue gas temperatures and CO concentrations for simulations involving modifications to relocate a portion of SWS vapor stream to downstream SNCR ports. FIG. 3 is a graphical representation of the average gas temperatures versus boiler length for the baseline case and for two modification cases involving relocation of a portion of the SWS vapor stream to SNCR ports located in the post-combustion zone. Case 2A is an example of 50% of the SWS vapor stream from the SWS being supplied to the CO Boiler, where all of this SWS vapor is provided as SNCR injection. Case 2B is an example of 50% of the SWS vapor from the SWS being supplied to CO Boiler, where only about 50% of the SWS vapor is provided as SNCR injection, while the other about 50% is mixed with the regen gas. The influence of modifications on the gas temperature in the horizontal combustion section can be seen from FIG. 3. However, downstream of plane 2, the average gas temperatures are similar for the modification cases and the baseline case.

FIG. 4 is a graphical representation of the average CO concentrations versus boiler length for the baseline case and for the two modification cases involving relocation of a portion of the SWS vapor to SNCR ports located in the post-combustion zone. FIG. 4 also shows that the CO concentration is low for all the cases after plane 2. This suggests that the modifications have negligible effects on the combustion efficiency.

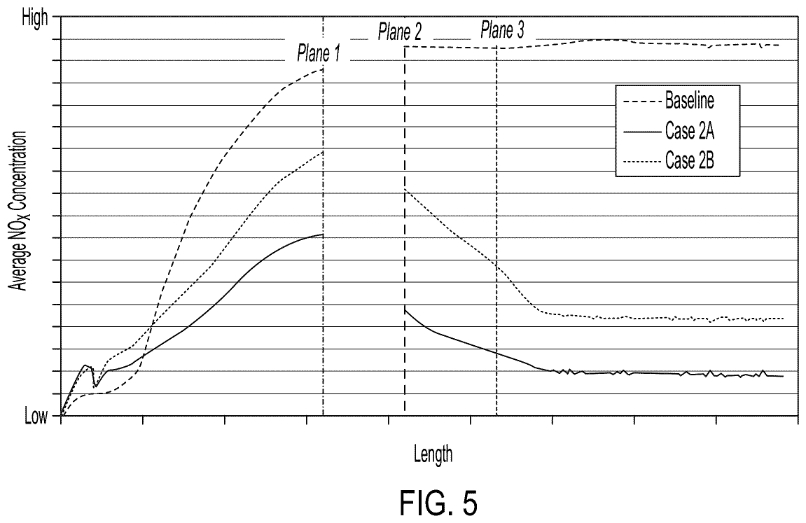

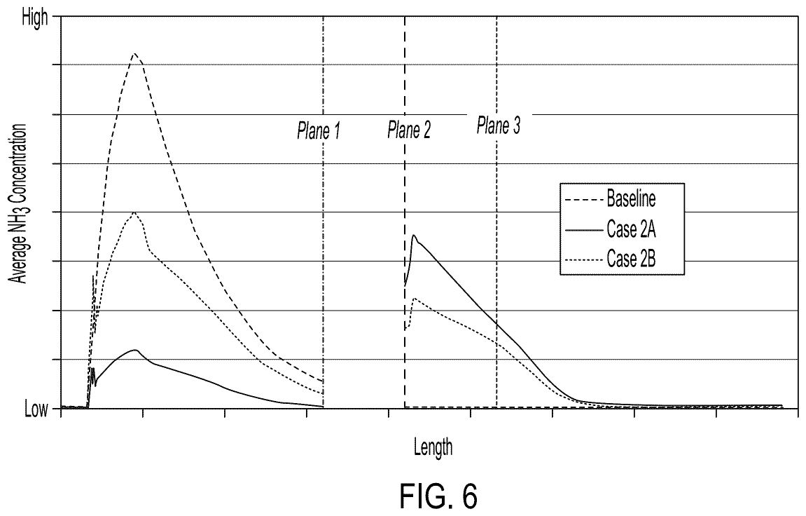

FIGS. 5 and 6 are graphical representations of the NOₓ concentrations and NH₃ concentrations, respectively, for the baseline case in comparison with the modification cases set forth above. As can be seen from FIG. 5, a significant decrease in NOₓ emission is predicted for both cases involving relocation of SWS vapor stream to the SNCR ports. The decrease in NOₓ is the result of both decreased NOₓ formation in the horizontal combustion zone due to less fuel-N species, and conversion of NOₓ to N₂ in the post-combustion zone with SNCR chemistry using SWS vapor as a SNCR reagent. These results indicate that the relocation of SWS vapor stream to the post-combustion SNCR zone abates NOₓ emissions in this type of CO boiler.

Similarly, for the tangentially fired CO boiler, baseline predicted gas temperatures, CO concentrations, and NOₓ concentrations before any proposed modifications were modeled. Based on predicted temperatures and CO concentrations, SNCR ports were simulated at a suitable location above the upper burner elevation. In this evaluation, a fixed portion of the total SWS vapor was mixed with the regen gas in the combustion zone, and incrementally increased SWS vapor flow rates through the SNCR ports were simulated, including low (SNCR 1), median (SNCR 2) and high (SNCR 3) SWS vapor flow rates. Table 1 presents the flow rate and other conditions for the baseline and three case analysis. For the modeling with low SWS vapor flow rate (SNCR 1), the processed exhaust gas contains about 50% lower NOₓ content compared to the NOₓ content when the exhaust gas is processed under similar conditions, but without the relocated SWS vapor stream. For the modeling with median SWS vapor flow rate (SNCR 2), the processed exhaust gas contains about 65% lower NOₓ content compared to the NOₓ content when the exhaust gas is processed under similar conditions, but without the relocated SWS vapor stream. For the modeling with high SWS vapor flow rate (SNCR 3), the processed exhaust gas contains about 73% lower NOₓ content compared to the NOₓ content when the exhaust gas is processed under similar conditions, but without the relocated SWS vapor stream.

TABLE 1
CFD modeling results for Example 1.

| | | | |
|---|---|---|---|
| Baseline | SNCR 1 | SNCR 2 | SNCR 3 |

Model Exit

| | | | | |
|---|---|---|---|---|
| NOₓ Emission at Model | 159 | 80 | 55 | 43 |
| Exit (ppmv, wet) | | | | |
| NOₓ Emission at Model | 185 | 94 | 65 | 50 |
| Exit (ppmv, dry) | | | | |
| NOₓ Emission at Model | 189 | 96 | 66 | 51 |
| Exit (ppmv @ 3% O₂ | | | | |
| dry) | | | | |
| Average NH₃ Concen- | <0.1 | 4 | 10.3 | 17.7 |
| tration at Model Exit | | | | |
| (ppmvw) | | | | |

Before SNCR Port

| | | | | |
|---|---|---|---|---|
| SWS as SNCR Reagent | N/A | 5,020 | 7,155 | 8,597 |
| Flow Rate (lb/hr) | | | | |
| NSR @ Predicted NOₓ | N/A | 1.8 | 2.6 | 3.1 |
| Level before SNCR | | | | |
| Ports | | | | |
| NOₓ From Regen Gas | 0.045 | 0.045 | 0.045 | 0.045 |
| (lbmol/hr) | | | | |
| NH₃ From Regen Gas | 1.241 | 1.241 | 1.241 | 1.241 |
| (lbmol/hr) | | | | |
| HCN From Regen Gas | 1.241 | 1.241 | 1.241 | 1.241 |
| (lbmol/hr) | | | | |

At or After SNCR Port

| | | | | |
|---|---|---|---|---|
| NH₃ From SWS | 8.817 | 6.756 | 8.374 | 9.466 |
| (lbmol/hr) | | | | |
| Total NOₓ + NH₃ + | 11.344 | 9.283 | 10.901 | 11.933 |
| HCN From Regen Gas + | | | | |
| SWS (lbmol/hr) | | | | |
| Predicted NOₓ at model | 2.331 | 1.165 | 0.813 | 0.625 |
| exit (lbmol/hr) | | | | |
| NOₓ Decrease (%) | NA | 50.0 | 65.1 | 73.2 |

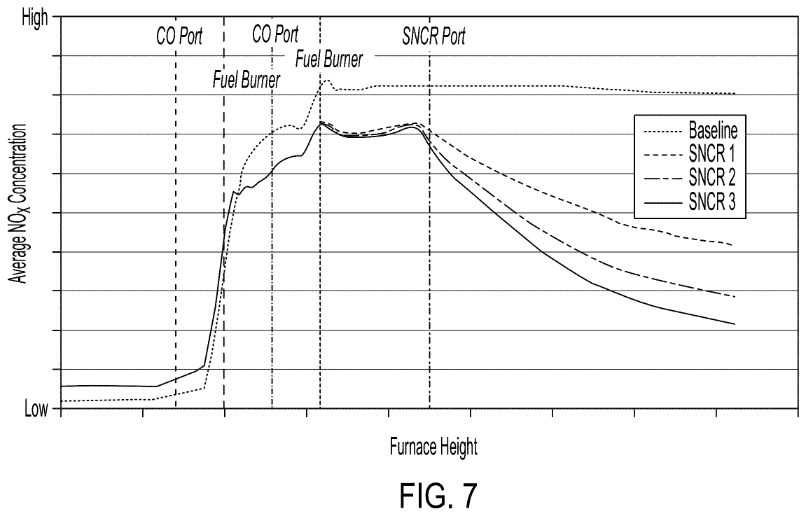

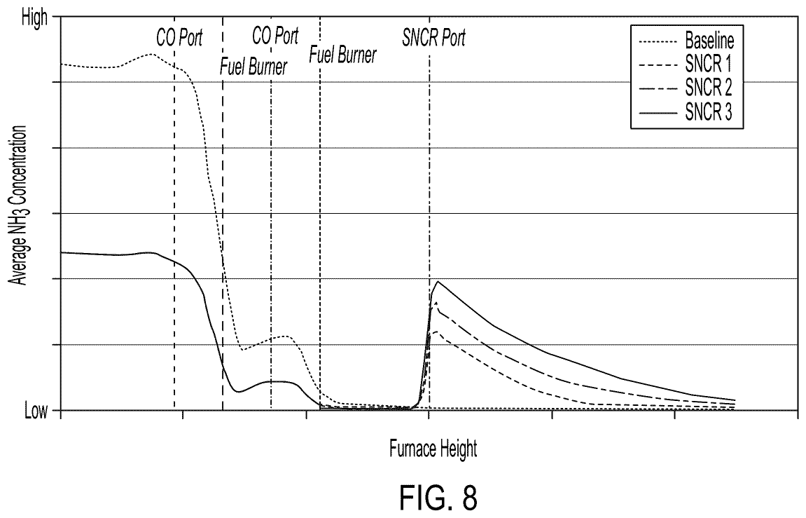

FIG. 7 is a graphical representation of NOₓ concentration as a function of boiler height for the baseline case and for the three modification cases set forth above (SNCR 1, SNCR 2, and SNCR 3). FIG. 8 is a graphical representation of the NH₃ concentration as a function of boiler height for the baseline case and the three modification cases the three modification cases set forth above (SNCR 1, SNCR 2, and SNCR 3). Significant decrease in NOₓ emission is predicted at the different SWS rates to the SNCR ports. NOₓ reduction increases as the amount of SWS gas to the SNCR ports increases. However, NH₃ slip is also increased, primarily due to reduced flue gas temperature in this boiler. These results indicate that optimization of the quantity of SWS vapor stream relocated to the SNCR ports can be dependent on what level of NH₃ slip is acceptable.

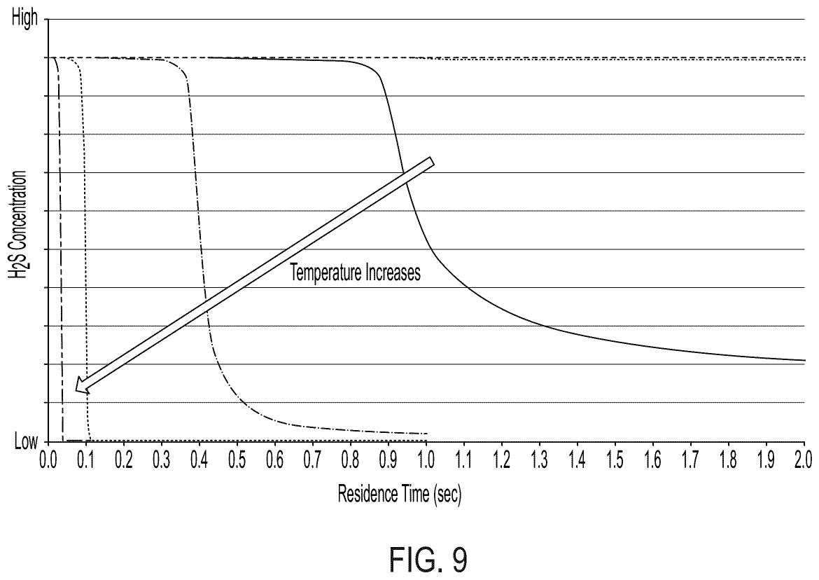

The SWS vapor may also contain H₂S and the relocation of the SWS vapor stream from the combustion zone to the SNCR ports in a CO boiler raises the potential concern of increased H₂S emissions. A preliminary evaluation was carried out to evaluate the potential for increased H₂S emissions. A series of isothermal plug flow calculations were carried out to evaluate the rate of oxidation of H₂S over a relevant temperature range. The results, as shown in FIG. 9, indicate a time lag associated with generation of the radical pool before the H₂S oxidation takes off. The residence time for complete oxidation of the H₂S at higher operating temperature is relatively short. The results show potential for significant H₂S oxidation at typical SNCR zone temperatures for the residence times that exist in both CO boilers simulated here. However, quantitative predictions of H₂S emissions should include the impacts of mixing, which can be achieved by integration of the chemical mechanism for H₂S oxidation into the CFD model.

Results of a CFD-based evaluation performed on two typical styles of CO boilers show that significant decreases in NOₓ can be obtained by relocating SWS vapor from the combustion zone to downstream SNCR ports in the boiler. NOₓ reduction is dependent on the flue gas temperature, available residence time, and the mixing of reagent and flue gas. NOₓ reduction was also impacted by the amount of SWS vapor that was directed to the SCNR ports, with greater NOₓ reduction seen with higher SWS rates to the SNCR ports. The decrease in NOₓ may be limited, however, by how much NH₃ slip can be tolerated, as the modeling also showed increased NH₃ slip at higher SWS vapor rates to the SCNR ports, especially for boilers that have colder operating temperatures. Detailed chemical kinetics calculations to evaluate the impact of temperature on H₂S oxidation indicate that there is significant H₂S oxidation at typical SNCR zone temperatures. However, impacts of mixing also needs to be considered, ideally within a CFD simulation, to obtain accurate predictions of the impact of SWS vapor stream relocation on H₂S emissions.

### Example 2

Initially, two baseline cases were developed to calibrate the CFD-based evaluation of a CO boiler (COB1) to actual operating conditions of COB1 using PI data and stack test data. For this example embodiment, the CFD model includes two COBs and extends to the steam generation bank outlet, where the expected gas temperature is well-below the reaction/oxidation temperatures of the species in question. The first baseline case represents a typical partial burn operation with SWS vapor split between COB1 and COB2. The process basis is presented in Table 2. SWS vapor flow rate is the balance of total flow after deducting the expected usage by COB2 NOₓ reduction facility. The decrease in NOₓ emissions is relative to the baseline and adjusted for SWS vapor flow difference between the cases. As used herein, the unit “MMBtu/hr” refers to millions of British Thermal Units per hour, and the unit “MMSCFD” refers to millions of standard cubic feet per day.

TABLE 2
Summary of CFD Results for Example 2.

| Process Parameter | Unit | Baseline 1 | SNCR 1 |
|---|---|---|---|
| Steam Make | klb/hr | 166 | 166 |
| Fuel Gas Flow Rate | MMSCFD | 3.1 | 3.1 |
| Fuel Gas Firing Rate | MMBtu/hr | 103 | 103 |
| Regen Gas (Before SWS | lb/hr | 229,754 | 229,754 |
| Injected Flow Rate) | | | |
| Regen Gas (Before SWS | ° F. | 1,162 | 1,162 |
| Injected Temperature) | | | |
| SWS Flow Rate to COB1 | lb/hr | 11,640 | 9,330 |
| SWS Flow Temperature | ° F. | 235 | 235 |
| SWS Used as SNCR Reagent | lb/hr | N/A | 5,430 |
| Flow Rate | | | |
| COB Exit Excess O₂ | vol. %, dry | 3.33 | 3.33 |
| Total Air Flow Rate | lb/hr | 177,495 | 177,495 |
| CO Burner air pre-mix flow | lb/hr | N/A | N/A |
| rate | | | |
| FG Burner Steam Injection | lb/hr | N/A | N/A |
| steam flow rate | | | |
| FG Burner Steam Injection | ° F. | N/A | N/A |
| steam Temperature | | | |
| COB Flue Gas Flow Rate | lb/hr | 424,089 | 421,779 |
| COB Flue Gas Adiabatic | ° F. | 1,998 | 2,012 |
| Temperature | | | |
| Average Flue Gas | ° F. | 654 | 656 |
| Temperature at Model Exit | | | |
| Average CO at future | ppmv | 900 | 900 |
| SNCR Ports Location | | | |
| Average CO at Model Exit | ppmv | <1 | <1 |
| (Steam Gen outlet) | | | |
| Average NOₓ Emission at | ppmv | 172 | 102 |
| Model Exit | | | |
| NOₓ Emission at Model Exit | lbmol/hr | 2.52 | 1.27 |
| NOₓ Emission Decrease | % | N/A | 37% |
| (relative to baseline level) | | | |
| Average NH₃ at Model Exit | ppmvd | <0.1 | 4 |
| Average HCN at Model Exit | ppmvd | 0.1 | 0.1 |

The second baseline case represents a typical partial burn operation with nearly identical regen gas flow and compositions, combustion air flow, boiler steam make, and burner fuel gas flow as the first baseline case. The only difference was that the SWS vapor was not delivered to COB 1 and instead was entirely provided to COB2. In both of these baseline cases, the SWS vapor was supplied in the combustion zone of the boiler.

When the combined HCN and NH₃ concentrations of 350 ppmvd in the regen gas was used, which is at the low end of the range as determined by prior operating data analysis, both baseline cases match the stack test readings reasonably well. The CFD modeling yielded a CO concentration of less than 1 ppm for Baseline case 1 and Baseline Case 2 (without SWS vapor), respectively, at model exit, which is consistent with the CO readings of zero from a continuous emission monitoring system (CEMS). The CFD modeling yielded a NOₓ emission of about 172 ppmv for the Baseline Case 1 at the model exit, aligning with the between 151 ppmv and 157 ppmv NOₓ emission reported in stack test. The CFD modeling yielded a NOₓ emission of 109 ppmv for the Baseline Case 2 (without SWS vapor) at the model exit, consistent with 117 ppmv reported in stack test for the Baseline Case 1. The CFD modeling yielded a 0.1 ppmv of NH₃ and HCN slip at model exit for both baselines. The model revealed that the high NOₓ concentration is laden in the annulus surrounding the center fire ball to some extent, where the CO concentration is relatively high.

In test case for use of SWS vapor as a SNCR agent, some of the NH₃-laden SWS vapor, which is pre-mixed with the regen gas before being injected into primary combustion zone via CO burners, is instead re-routed to cooler locations (namely SNCR zone) downstream of the combustion zone in the COB1 furnace. The SNCR nozzles are located in the wall boxes of the furnace water walls. Rerouting SWS vapor has several positive impacts on NOₓ emissions. It eliminates a large source of NOₓ precursors from being converted to NOₓ in the highest temperature zone (primary combustion zone) of the furnace and provides the NOₓ reduction reagent (NH₃) to destroy the NOₓ, including NOₓ produced in the combustion zone, via SNCR chemistry.

The amount of SWS vapor, which can be routed to COB1 SNCR zone, depends on the SWS vapor consumption at COB2 SNCR, stack NOₓ, and the acceptable levels of NH₃ slip for long term reliable operation. For approximately 85% of the time, the SWS vapor contains sufficient NH₃ for the SNCR demands of both COB1 and COB2 during the normal operation (partial burn mode). Other embodiments may include a supplemental NH₃ system, such as an NH₃ storage tank, an NH₃ vaporization/mixing/distribution skid, and associated instrument and piping.

The SNCR design for COB1 includes a total of four SNCR wall injectors installed in the water wall, with two injectors installed in a first side wall, and two injectors installed in the same locations of the opposite side wall. All injectors are to be positioned horizontally without tilt and yawn angles for this example embodiment. The injector size is nominal 2 inch schedule (SCH) 80 piping and is uniform for all four wall injectors for this example embodiment.

For this example embodiment, the SWS vapor stream delivered to COB1 can be split into two streams. The existing SWS vapor stream injecting to the regen gas line will remain. A new SNCR supply line is diverted from the existing SWS line upstream of the existing SWS vapor injection point. This line provides the reagent to the SNCR injectors of COB1. The injectors can be steam purged to prevent them from plugging and overheating when the SNCR system is out of service. The purge steam can also provide a minimum flow to the SNCR nozzles in order to achieve a required nozzle exit velocity in the case of low SWS vapor flow. A CFD case was run to verify the design concept, optimize the SNCR injector locations, and quantify the NOₓ reduction rate and NH₃ slip.

For this example embodiment, a portion of the SWS vapor stream previously routed to the primary combustion zone of COB1 is rerouted to the SNCR injectors to maintain a normalized stoichiometric ratio (NSR) of approximately 2 at the SNCR zone of COB1. NSR is defined as the molar ratio of NH₃ to NOₓ at the SNCR inlet. The portion of the SWS vapor stream routed to COB1 is the balance of total SWS vapor stream less the amount consumed at COB2 to maximize COB2 SNCR performance. The amount of NOₓ is decreased to 102 ppmvd, which represents a 45% lower NOₓ content relative to the model baseline level of 185 ppmvd, or represents a 35% lower NOₓ content relative to the COB1 stack test level of 157 ppmvd. The model predicted an average NH₃ slip of 4 ppmvd and a CO emission of less than 1 ppmvd. SNCR zone efficiency is 36% (based on the NOₓ concentration at SNCR zone inlet). SNCR zone efficiency represents the percentage of NOₓ that is reduced due to the SNCR reaction. The total decrease in NOₓ content is 45% relative to the baseline case due to the additional NOₓ reduction as a result of the relocation of part of the SWS vapor stream to the SNCR injectors.

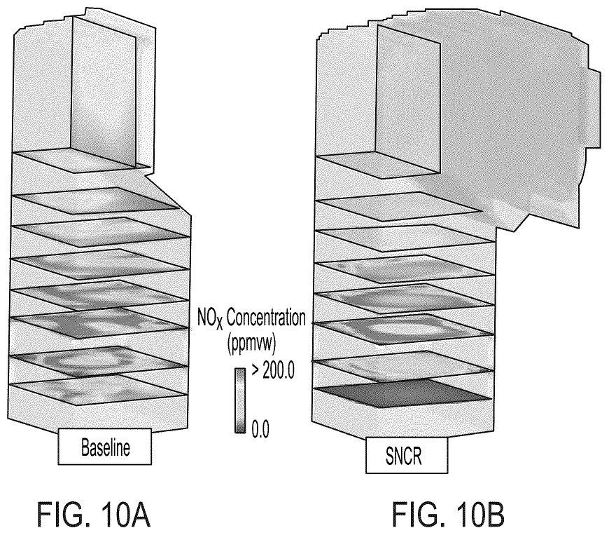

As shown, the case involving relocating a portion of the SWS vapor stream to serve as the SNCR reagent (case SNCR 1) results in significant decrease in NOₓ emissions of 45% relative to the model baseline level. FIGS. 10A and 10B are illustrations from the CFD modeling of the NOₓ profiles of SNCR case (FIG. 10B) in comparison with the baseline case (FIG. 10A). Table 3 shows the decrease in NOₓ emissions at the individual boilers exit and the common water gas shift reactor (WGS) stack when two COBs are to implement the SNCR facility during the normal operation. As used herein, the unit “lbmol/hr” refers to pound mole per hour.

TABLE 3
Expected NOₓ reduction rate and emissions at stack for Example 2.

| | | | | WGS |
|---|---|---|---|---|
| | Unit | COB2 | COB1 | Stack |
| Baseline uncontrolled NOₓ | ppmvd | 322 | 154 | 247 |
| (corrected to 3% O₂) | | | | |
| Baseline uncontrolled NOₓ | lbmol/hr | 4.64 | 1.94 | 6.58 |
| flow | | | | |
| Best NOₓ reduction rate by | % | 77 | 37 | 65 |
| SNCR | | | | |
| NOₓ flow reduced by SNCR | lbmol/hr | 3.57 | 0.72 | 4.29 |
| NOₓ flow after SNCR | lbmol/hr | 1.07 | 1.22 | 2.29 |
| treatment | | | | |
| NOₓ concentration after | ppmvd | 74 | 97 | 86 |
| SNCR treatment (corrected | | | | |
| to 3% O₂) | | | | |
| NH₃ slip | ppmvd | 10 | 4 | 8 |
| HCN slip | ppmvd | 10 | 4 | 8 |
| CO emissions | ppmvd | <5 | <5 | <5 |

### Example 3

Another example embodiment of a system with COB1 and COB2 was subject to CFD modeling following relocation of a portion of the SWS vapor stream to serve as a SNCR reagent. Three configurations were evaluated, and the results are presented in Table 4. In the baseline configuration, 50% of the SWS vapor stream from the SWS unit is supplied to each of the COB1 and COB2 (an Alcorn refractory wall furnace). The 50% of the SWS vapor stream routed to COB2 is supplied as a part of the exhaust gas in the combustion zone of the furnace in the baseline configuration. In the first SNCR configuration (SNCR1_100% SWS), 50% of the SWS vapor stream from the SWS unit is supplied to each of COB1 and COB2, and the entirety of the SWS vapor stream routed to COB2 is injected through SNCR injectors into the combusted exhaust gas in the post-combustion zone. In the second SNCR configuration (SNCR2_50% SWS), 50% of the SWS vapor stream from the SWS unit is supplied to each of COB1 and COB2, where half of the SWS vapor stream supplied to the COB2 is supplied to COB2 in the combustion zone and the other half is injected through SNCR injectors into the combusted exhaust gas in the post-combustion zone of COB2. In the third SNCR configuration (SNCR3_DSWS_50% SWS), none of the SWS vapor stream from the SWS unit is supplied to COB1 and the entirety of SWS vapor stream from the SWS unit is instead supplied only to COB2, where about 50% of the SWS vapor stream delivered to COB2 is supplied as a part of the exhaust gas in the combustion zone of the furnace, and the remaining about 50% of the SWS vapor stream delivered to COB2 is injected through SNCR injectors into the combusted exhaust gas in the post-combustion zone. The results from the baseline and these three configurations are provided in Table 4.

TABLE 4
Results from the baseline case and the three modification cases for Example 3.

| | | SNCR1_100% | SNCR2_50% | SNCR3_DSWS_50% |
|---|---|---|---|---|
| | Baseline | SWS | SWS | SWS |
| SWS vapor flow to | 13,452 | 13,452 | 13,452 | 26,904 |
| COB2 (lb/hr) | | | | |
| SWS vapor flow as | — | 13,452 | 6,726 | 13,452 |
| SNCR reagent (lb/hr) | | | | |
| NSR | — | 3.8 | 1.3 | 2.3 |
| Average Flue Gas | 825 | 829 | 824 | 822 |
| Temperature at Model | | | | |
| Exit (° F.) | | | | |
| Average O₂ at Model | 3.81 | 3.78 | 3.77 | 3.73 |
| Exit (vol %, dry) | | | | |
| Average CO at Model | <1 | <1 | <1 | <1 |
| Exit (ppmv, dry) | | | | |
| NOₓ Emission at Model | 338 | 42 | 101 | 69 |
| Exit (ppmv, dry) | | | | |
| NOₓ Emission at Model | 4.98 | 0.61 | 1.48 | 1.0 |
| Exit (lb-mol/hr) | | | | |
| NH₃ Slip at Model Exit | <1 | 4 | 2 | 21 |
| (ppmv, dry) | | | | |

For this example embodiment, the regen gas contains HCN, NOₓ, and NH₃. In this example embodiment, the SWS vapor stream contains about 1.2 wt. % of NH₃ and 98.8 wt. % steam. This composition of SWS vapor stream and NH₃/NOₓ ratio is typical for a steam-vaporized NH₃ injection SNCR system. Relocation of the SWS vapor stream away from the primary combustion zone has a significant impact on diminishing NOₓ formation. Piping was modeled to route all or part of the SWS vapor away from the combustion zone by installation of eight 2 inch SNCR nozzles to inject SWS vapor as SNCR reagent and two control valves to control the SWS vapor split between regen gas line and SNCR nozzles.

In the first configuration, the NOₓ emission decreased to about 42 ppmv, the CO emission was less than 1 ppmv, and the NH₃ slip was about 4 ppmv. In the second configuration, the NOₓ emission decreased to about 101 ppmv, the CO emission was less than 1 ppmv, and the NH₃ slip was about 2 ppmv. In the third configuration, the NOₓ emission was decreased to about 69 ppmv, the CO emission was less than 1 ppmv, and the NH₃ slip was about 21 ppmv.

As such, this example indicates that significant NOₓ emissions reduction is possible when SWS vapor is used as a SNCR reagent. The NH₃ slip was small and the conditions for SNCR activity and NOₓ destruction was optimum in COB2. The CO emission was less than 1 ppmv, as conditions in the furnace/boiler were sufficient for continued CO destruction.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

The present application claims priority to and the benefit of U.S. Provisional Application No. 63/378,821, filed Oct. 7, 2022, titled “Methods and Systems for Reducing Nitrogen Oxide Emissions in a Heat Generation Unit using Sour Water Stripper Vapor,” the disclosure of which is incorporated herein by reference in its entirety for all purposes.

Other objects, features and advantages of the disclosure will become apparent from the foregoing drawings, detailed description, and examples. These drawings, detailed description, and examples, while indicating specific embodiments of the disclosure, are given by way of illustration only and are not meant to be limiting. In further embodiments, features from specific embodiments may be combined with features from other embodiments. For example, features from one embodiment may be combined with features from any of the other embodiments. In further embodiments, additional features may be added to the specific embodiments described herein. It should be understood that although the disclosure contains certain aspects, embodiments, and optional features, modification, improvement, or variation of such aspects, embodiments, and optional features can be resorted to by those skilled in the art, and that such modification, improvement, or variation is considered to be within the scope of this disclosure.

What is claimed is:

1. A method for reducing NOₓ in a heat generation unit, the method comprising:
introducing an exhaust gas from a cracking unit to a combustion zone of the heat generation unit to produce a combusted exhaust gas, the exhaust gas containing two or more of carbon monoxide (CO), hydrogen cyanide (HCN), ammonia (NH₃), and NOₓ;
introducing a sour water stripper (SWS) vapor stream from a SWS unit to the heat generation unit at a location after the combustion zone and before a heat recovery zone of the heat generation unit; and
allowing the SWS vapor stream to react with the combusted exhaust gas to produce a processed exhaust gas with a decreased NOₓ content compared to a NOₓ content when the exhaust gas is processed under similar conditions but without an interaction with the SWS vapor stream.

2. The method of claim 1, wherein the SWS vapor stream is introduced in at least two temperature sections of the heat generation unit, the temperature sections being defined by a range of temperature of the combusted exhaust gas, and the at least two temperature sections being a first temperature section ranging from about 1600° F. to about 1800° F. and a second temperature section ranging from about 1800° F. to about 2200° F.

3. The method of claim 1, wherein the SWS vapor stream is introduced in at least three temperature sections of the heat generation unit, the temperature sections being defined by a range of temperature of the combusted exhaust gas, and the at least three temperature sections being a first temperature section ranging from about 1600° F. to about 1800° F., a second temperature section ranging from about 1800° F. to about 1900° F., and a third temperature section ranging from about 1900° F. to about 1955° F.

4. The method of claim 1, wherein the cracking unit is a fluid catalytic cracking unit.

5. The method of claim 1, wherein the NOₓ content in the processed exhaust gas is about thirty percent less than the NOₓ content when the exhaust gas is processed under similar conditions but without the interaction with the SWS vapor stream.

6. The method of claim 1, wherein the NOₓ content in the processed exhaust gas is about fifty percent less than the NOₓ content when the exhaust gas is processed under similar conditions but without the interaction with the SWS vapor stream.

7. The method of claim 1, wherein the NOₓ content in the processed exhaust gas is about seventy percent less than the NOₓ content when the exhaust gas is processed under similar conditions but without the interaction with the SWS vapor stream.

8. A method of operating a heat generation unit, the method comprising:
combusting a regeneration (regen) gas stream in a combustion zone of the heat generation unit to produce a combusted regen gas that contains NOₓ;
injecting a sour water stripper (SWS) vapor stream that contains ammonia (NH₃) as a selective non-catalytic reduction (SNCR) reagent into a post-combustion zone of the heat generation unit; and
allowing the NH₃ of the SWS vapor stream to react with the NOₓ of the combusted regen gas in the post-combustion zone of the heat generation unit to produce a processed exhaust gas having a decreased NOₓ content.

9. The method of claim 8, comprising receiving the regen gas stream from a fluid catalytic cracking unit, wherein the regen gas stream contains carbon monoxide (CO) and one or more nitrogen-containing compounds.

10. The method of claim 9, wherein the one or more nitrogen-containing compounds are selected from the group consisting of: hydrogen cyanide (HCN), ammonia (NH₃), and NOₓ.

11. The method of claim 8, comprising receiving the SWS vapor stream from a SWS unit, wherein the SWS vapor further contains steam and H₂S.

12. The method of claim 8, wherein the post-combustion zone of the heat generation unit is disposed downstream of the combustion zone and upstream of a heat recovery zone of the heat generation unit.

13. The method of claim 8, wherein injecting the SWS vapor stream into the post-combustion zone of the heat generation unit comprises:
injecting the SWS vapor stream in at least two temperature sections of the post-combustion zone, the temperature sections being defined by a range of temperature of the combusted regen gas, and the at least two temperature sections being a first temperature section ranging from about 1600° F. to about 1800° F. and a second temperature section ranging from about 1800° F. to about 2200° F.

14. The method of claim 8, wherein injecting the SWS vapor stream into the post-combustion zone of the heat generation unit comprises:
injecting the SWS vapor stream in at least three temperature sections of the post-combustion zone, the temperature sections being defined by a range of temperature of the combusted regen gas, and the at least three temperature sections being a first temperature section ranging from about 1600° F. to about 1800° F., a second temperature section ranging from about 1800° F. to about 1900° F., and a third temperature section ranging from about 1900° F. to about 1955° F.

15. The method of claim 8, wherein the processed exhaust gas contains less than 300 parts per million by volume-dry (ppmvd) of NOₓ, less than 1 part per million by volume-wet (ppmvw) of CO, and about 20 ppmvd or less of NH₃.

16. The method of claim 15, wherein the processed exhaust gas contains about 100 ppmvd or less of NOₓ and about 5 ppmvd or less of NH₃.

17. The method of claim 8, wherein the decreased NOₓ content of the processed exhaust gas is at least 30% less than a NOₓ content of the combusted regen gas.

18. A heat generation system, comprising:
an exhaust gas conduit for conveying an exhaust gas from a cracking unit to a furnace unit;
the furnace unit containing (i) a combustion zone to receive the exhaust gas and facilitate combustion of the exhaust gas to produce a combusted exhaust gas, (ii) a post-combustion zone equipped with a plurality of inlets to inject a plurality of sour water stripper (SWS) vapor streams from a SWS unit into the combusted exhaust gas from the combustion zone to produce a processed exhaust gas, and (iii) a heat recovery zone to capture heat from the processed exhaust gas; and
a vent conduit for emission of the processed exhaust gas after passing through the heat recovery zone, the processed exhaust gas containing a decreased NOₓ content as compared to a NOₓ content when the exhaust gas is processed under similar conditions but without an interaction with the plurality of SWS vapor streams.

19. The heat generation system of claim 18, wherein the plurality of inlets includes at least one inlet disposed in each of at least two temperature sections in the post-combustion zone, the temperature sections being defined by a range of temperature of the combusted exhaust gas, and the at least two temperature sections being a first temperature section ranging from about 1600° F. to about 1800° F. and a second temperature section ranging from above 1800° F. to about 2200° F.

20. The heat generation system of claim 18, wherein the plurality of inlets includes at least one inlet disposed in each of at least three temperature sections in the post-combustion zone, the temperature sections being defined by a range of temperature of the combusted exhaust gas, and the at least three temperature sections being a first temperature section ranging from about 1600° F. to about 1800° F., a second temperature section ranging from above 1800° F. to about 1900° F., and a third temperature section ranging from above 1900° F. to about 1955° F.

21. The heat generation system of claim 18, wherein an additional SWS vapor stream from the SWS unit is supplied to the combustion zone and processed along with the exhaust gas to produce the combusted exhaust gas.

22. The heat generation system of claim 18, wherein the NOₓ content in the processed exhaust gas is about thirty percent less than the NOₓ content when the exhaust gas is processed under similar conditions but without the interaction with the plurality of SWS vapor streams.

23. The heat generation system of claim 18, wherein the NOₓ content in the processed exhaust gas is about fifty percent less than the NOₓ content when the exhaust gas is processed under similar conditions but without the interaction with the plurality of SWS vapor streams.

24. The heat generation system of claim 18, wherein the NOₓ content in the processed exhaust gas is about seventy percent less than the NOₓ content when the exhaust gas is processed under similar conditions but without the interaction with the plurality of SWS vapor streams.

25. A system, comprising:
a sour water stripper (SWS) unit configured to generate a SWS vapor stream that contains ammonia (NH₃) and steam; and
a carbon monoxide (CO) boiler containing a combustion zone and a post-combustion zone, the post-combustion zone having selective non-catalytic reduction (SNCR) nozzles configured to receive and inject a portion of the SWS vapor stream into a combusted exhaust gas from the combustion zone to produce a processed exhaust gas having decreased NOₓ content.

26. The system of claim 25, comprising a fluid catalytic cracking unit in fluid communication with the CO boiler and configured to provide a regeneration (regen) gas stream to the combustion zone of the CO boiler, wherein at least the regen gas stream is combusted in the combustion zone to generate the combusted exhaust gas.

27. The system of claim 26, wherein a second portion of the SWS vapor stream is combined with the regen gas stream before being combusted together in the combustion zone to generate the combusted exhaust gas.

28. The system of claim 25, wherein the processed exhaust gas contains less than 300 parts per million by volume-dry (ppmvd) of NOₓ, less than 1 part per million by volume-wet (ppmvw) of CO, and about 20 ppmvd or less of NH₃.

29. The system of claim 25, wherein the CO boiler is a wall-fired CO boiler or a tangentially-fired CO boiler.

30. The system of claim 25, wherein a molar ratio of NH₃ to NOₓ in the post-combustion zone is between about 1.3 and about 3.8.
